(19) United States
(12) Patent Application Publication
(10) Pub. No.: US 2014/0253334 A1
(43) Pub. Date: Sep. 11, 2014

(54) METHOD AND MEANS FOR PROMOTING HEALTH

(71) Applicant: ECOLAB USA INC., St. Paul, MN (US)

(72) Inventors: John Henry Hanlin, Maple Grove, MN (US); Graeme Kere Kemp, Mercer Island, WA (US)

(73) Assignee: ECOLAB USA INC., St. Paul, MN (US)

(21) Appl. No.: 13/790,856

(22) Filed: Mar. 8, 2013

(51) Int. Cl. G08B 21/24

(52) U.S. Cl. CPC G08B 21/245
USPC 340/573.1

(57) ABSTRACT

A method and means of promoting health and hygiene is provided. A plurality of health related messages directed to the promotion of health and hygiene are included at or near a product dispenser. One or more of the health related messages are provided to be communicated to an individual. The messages may relate to the instructions for use of the product, recommendations of the product, general facts related to health and hygiene or an alert, such as a seasonal or other outbreak of an illness. The messages will be used to remind individuals of good health and hygiene practices in order to reduce the transfer of illnesses or diseases between individuals.

### FIELD OF THE INVENTION

The invention relates generally to the promotion of health and healthy lifestyles. More particularly, but not exclusively, the invention relates to methods and means for communicating health advice and alerts relating to products in order to promote a more healthy society.

### BACKGROUND OF THE INVENTION

Many studies have reported an associated between the benefits of proper hand hygiene and a reduction in the rates of infectious illnesses. For example, in the article “Effect of Hand Hygiene on Infectious Disease Risk in the Community Setting: A Meta-Analysis”, published in the American Journal of Public Health, the authors searched four databases for hand-hygiene trials published from January 1960 through May 2007. The study showed that proper hand hygiene reduced the risk of gastrointestinal illnesses and some respiratory illnesses.

Other studies have found similar results, with many finding that using soap to wash hands can reduce approximately 95% of diseases exposed to the hands. Furthermore, the effectiveness of soaps depends on wash time and soap volume. As noted by one study, range of soap volumes used for handwashing tends to be between one and three milliliters and using three milliliters of antiseptic soap resulted in a significantly greater reduction in log microbial counts than one milliliter of soap. Recommended handwash times range from 15 to 30 seconds by different agencies around the world with slightly different emphasis. The World Health Organization suggests it should take 40-60 seconds for washing hands with soap and water, then rinsing and drying them 20-30 seconds to disinfect the hands with an alcohol-based formulation.

However, even though the benefits of proper hand hygiene have been known, many people still choose to either ignore the benefits or to forget, and do not take the proper steps and procedures to reduce the spreading of illnesses and/or diseases. Actual observations of workers in different settings show less time is spent on actual washing than recommended: 4.7 to 48 seconds in studies of wash events, for a typical time of 9.5 seconds. In other studies, the public was observed after using the restroom/toilet in public, school and household settings: only 58-92% washed with water and of those that did so, only 8-50% used soap. In a foodservice study, workers of both sexes washed 32% of the time and those that did used soap 28% of the time; the average time taken to wash hands was 9 seconds, with 58% taking 7-11 seconds. It is of concern that these figures show no real difference between the workers wash habits and those of the general public/school children, indicating that less than a third of workers washed their hands, and fewer used soap after any number of potentially contaminating events in food preparation settings.

In addition, improper technique related to scrubbing and drying can also cause hygiene problems. Aggressive scrubbing can cause cracked skin and sores that adversely affect hand hygiene. The use of brushes, particularly, can cause the skin to become red, dry, chapped, and rough, making the primary barrier against microbial invasion subject to infection. Drying, when done properly, can provide a further 90% reduction in transient flora. It has been found that the friction generated during hand drying is even more important than during washing because the soaping stage has loosened the microorganisms from the skin.

Therefore, there exists a need in the art for method and system that promotes good hygiene by providing reminders, instruction, data, and product location at or near a product, such a soap, lotion, detergent, or the like, to provide for increased awareness of the benefits of good hygiene, and to reduce the likelihood of transferring an illness or disease, such as a food borne illness or disease.

Furthermore, it should be noted that the likelihood of passing an illness or food borne disease can be increased during certain times of the year. For example, there is a well-established “flu season”, wherein there is a higher number of flu cases reported. There are also times throughout the year where pandemics or outbreaks may occur, such as an avian flu outbreak. Other times there may be an outbreak of food-related diseases, such as an E. coli outbreak. At times of higher likelihood of the transferal of a disease or illness, it is even more important to promote good hygiene, both in the general public and especially for food industry workers or high traffic public locations.

Thus, there exists a further need for a method and system to be able to continually update hygiene or health-related messages at or near products in public locations, including restaurants, parks, bars, hotels, and the like, to provide alerts or notice of pandemics, outbreaks, or other times of high-risk passing of an illness or food borne disease, in order to further promote good hygiene by showing additional reasons for the need to properly wash and care for a person's body parts.

### SUMMARY OF THE INVENTION

It is therefore a primary object, feature, and/or advantage of the present invention to provide a method and system for identifying a product.

It is another object, feature, and/or advantage of the present invention to provide a method and system to communicate public health handwashing messages at a point of use.

It is yet another object, feature, and/or advantage of the present invention to provide a method and system that will allow operator and/or manufacturer to tailor a handwash message to a time of year, an event, or a timely public health issues such as flu season or acute gastroenteritis.

It is still another object, feature, and/or advantage of the present invention to provide a dispenser that will allow for universal handwashing reminders and messages in different languages to be provided.

It is a further object, feature, and/or advantage of invention to provide a method of providing changeable, health-related messages to promote better hygiene.

It is yet a further object, feature, and/or advantage of the present invention to provide a method and system to provide health-related messages that will provide audible reminders, instructions, and/or alerts upon an action, such as entering a room, using a faucet or toilet, or walking past a product.

It is still a further object, feature, and/or advantage of the present invention to provide a method and system for promoting health and hygiene that will reduce the passing of illnesses and/or diseases between food workers and customers. These and/or other objects, features, and advantages of the present invention will be apparent to those skilled in the art. The present invention is not to be limited to or by these objects, features and advantages. No single embodiment need provide each and every object, feature, or advantage.

According to an aspect of the invention, a method of promoting health and hygiene is provided. The method includes providing a plurality of health-related messages directed to the promotion of health, selecting a health-related message based upon a suggested behavior or an alert, and communicating the health-related message at or near a product related to the selected message to promote the use of the product. The health related messages may comprise one or more messages related to food safety, a hygiene reminder, a health alert, a seasonal health condition, or an instruction for the product.

The step of communicating the message may be accomplished by placing an identifier containing the message at or near the product dispenser, by displaying an electronic message, such as a video at or near the product dispenser, or by playing an audio clip of the message.

According to another aspect of the invention, a system for promoting health and hygiene is provided. The system includes a plurality of health-related messages directed to the promotion of health, and a communication device for communicating a selected health-related message at or near a product related to the selected message. The communication device includes means for changing the communicated health-related message.

According to yet another aspect of the invention, a method of promoting health and hygiene is provided. The method includes providing a plurality of health-related messages directed to the promotion of health, selecting a health-related message based upon a suggested behavior for a product related to health, and displaying the health-related message at the product to promote the use of the product.

### BRIEF DESCRIPTION OF THE DRAWINGS

FIG. 1 is a perspective view of a dispensing system having a replaceable health message identification according to the present invention.

FIG. 2 is a perspective view of the dispensing system of FIG. 1 in an open position.

FIG. 3 is an internal and rear view of a first body portion of the dispensing system of FIG. 1 showing the replaceable health message identification of the present invention.

FIG. 4 is a perspective view of a plurality of health message identifiers that can be used with the dispensing systems of the present invention.

FIGS. 5A-5E are examples of health messages that could be used with the message identifiers.

FIG. 6 is a schematic of various changes and options for the dispensing system of the present invention.

### DETAILED DESCRIPTION OF THE PREFERRED EMBODIMENTS

The present invention relates to the promotion and awareness within the general public and also food service and other service industry staff about the importance of handwashing and general hand hygiene. The invention includes a number of changeable or replaceable messages relating to the promotion of good hand hygiene to reduce the spread of infectious illnesses and foodborne diseases. Therefore, the invention relates to the promotion of good handwashing practice and general hand hygiene with respect to generally public places, such as restaurants, hotels, parks, and other public places. However, the invention is not limited to those locations described, and can be used generally anywhere with regard to the promotion of good handwashing practice and hand hygiene. Therefore, an aspect of the invention provides for the creation of relevant attention grabbing messaging around hand hygiene and washing products, such as at the point of use of said products. For example, the attention grabbing, health-related messages related to good handwashing and hygiene practices may be positioned at a soap or lotion dispenser, such that the messages at the dispenser can be changed to provide different options. For example, some messages relate to general reminders for the use of the hygiene product, while others may relate to general seasonal health conditions, such as the flu or cold, to information regarding foodborne diseases, to instructions for use of the product, or for general health alerts, such as alerts regarding recent disease or illness outbreaks. However, it is to be appreciated that the changeable messages of the present invention are not limited to those specific situations describe above, and may generally include any message related to the promotion of good handwashing practice and good health and hand hygiene.

Therefore, the present invention contemplates the use of one or more of the plurality of interchangeable messages on or near the hygiene products. For example, while the above scenario describes using the messages at the dispenser, it should also be appreciated that the messages may be displayed or otherwise communicated near the point of use of the products. Thus, the messages may be communicated to the public or staff in the general location of the product. For example, an electronics display, such as a screen, may also include a speaker for providing audio announcements to a person in the general area of the product to remind them of the use of the hygiene product and also to instruct them for the use of the product. The communication may also provide for alerts, such as communicating recent outbreaks of seasonal illnesses and/or other illnesses.

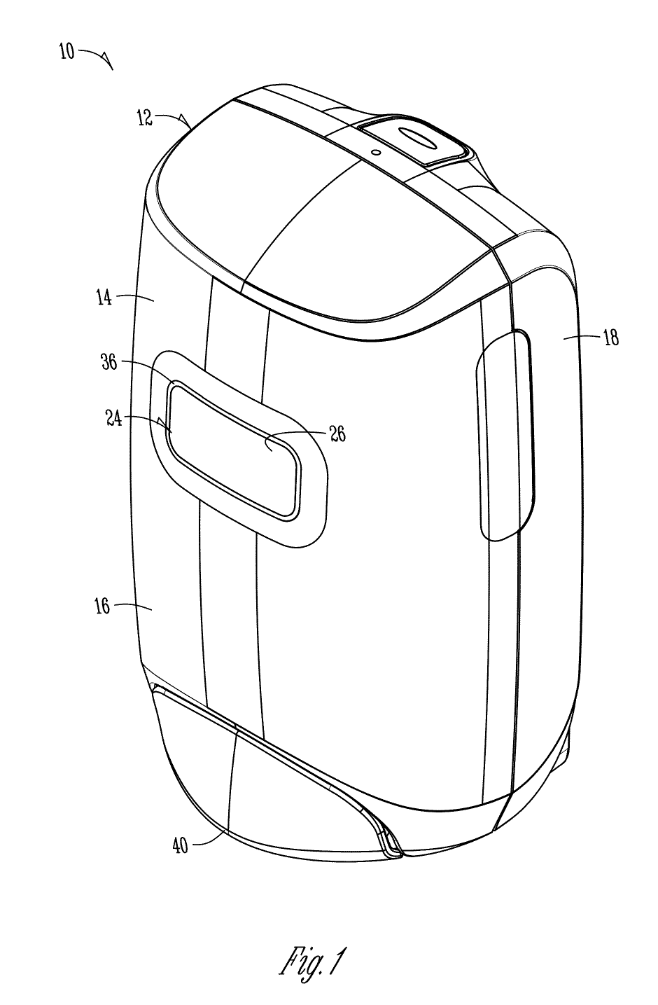

It is to be appreciated that providing a plurality of interchangeable messages to both the general public and food industry or other service staff members may mitigate the transferal of illnesses, disease, or the like by the promotion of good handwashing practices and overall health hygiene. By providing visual and audio reminders, instructions, alerts and the like, the users will be more likely to practice the good handwashing and hygiene tips related to the various products, such as soap, antiseptics, lotion, disinfectants, and the like. FIG. 1 is a perspective view of a dispensing system 10 having a message communication device 24 containing a message 26 thereon. The communication device 24 shown in use with the dispenser 10 of FIG. 1 may be a message identifier 24 shown through a window 36 in or through the dispenser body 14. Thus, the dispensing system 10 includes a dispenser 12 having a dispenser body 14. The dispenser 12 is shown to be a hand dispenser, such as the kind used to dispense hand soap, lotion, antiseptics, disinfectants, or the like. However, it should be appreciated that the present invention is not limited to hand dispensers, and includes any type of dispensing or consumable product dispensing device or system, as well as other types of faucets, dryers, such as towels and air dryers, or the like. The hand dispenser 12 of FIG. 1 is shown merely for exemplary purposes.

The dispenser body 14 comprises a first portion 16 and a second portion 18. The second portion 18 of the dispenser body 14 is generally affixed to a wall, stand, or other surface. The second portion may be hung, bolted, or otherwise affixed to the wall or stand and is generally stationary in relation to the affixed member or surface. The first portion 16 of the dispenser body 14 is moveable in relation to the second portion 18. The movability of the first portion 16 allows an operator to open the dispenser 12 to fill, replace, or otherwise have access to an interior of the dispenser 12. As shown in the figures, the first portion 16 is hingeably connected to the second portion 18 about a hinge 20. Therefore, the first portion 16 is able to rotate about said hinge to provide access to an interior of the dispenser 12. Furthermore, the dispenser 12 is shown to have a dispenser outlet 40 generally at the bottom portion of the dispenser body 14.

As mentioned, the dispenser 12 of FIG. 1 includes a communication device, in this case a message identifier 24. The message identifier may be part of the first portion 16 of the dispenser body 14. The first and second portion 16, 18 of the dispenser body 14 may generally comprise a plastic material, which may be molded or otherwise formed to form the components. Thus, the location for the message identifier 24 may be formed, such as molded, as part of the dispenser body 14. The message identifier 24 can includes a changeable message 26 that can be shown through a translucent window 36 in the first portion 16 of the dispenser body 14.

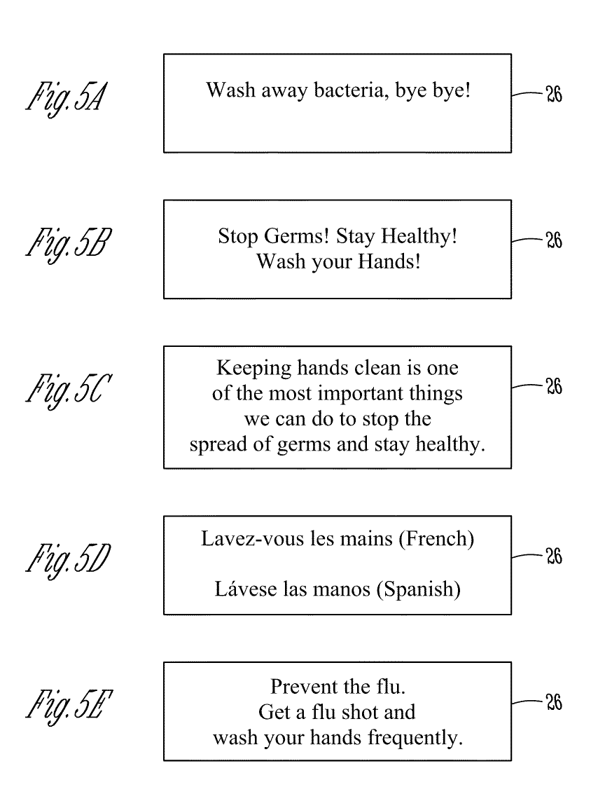

As mentioned, the message 26 may include various source of information. For example, the message 26 may include health related messages related to food safety, a hygiene reminder, a health alert, a seasonal health condition, and/or an instruction for the use of the product or dispenser. In addition, the present invention contemplates that the message 26 on the message identifier 24 includes more than one type of message. Examples of possible messages are shown in FIGS. 5A-5E. thus, the messages include reminders, instructions, alerts, or combinations thereof to promote the benefits of good handwashing practice and overall good hygiene. It is noted that the messages shown in FIGS. 5A-5E are not to be an exhaustive list of possible messages for use with the present invention, and are merely shown for exemplary purposes. In addition, as shown in FIG. 5D, the messages may also be provided in other languages. It is further contemplates that a dispenser, such as the dispenser 12 shown in the Figures, may include more than one of the messages shown in FIGS. 5A-5E, while also providing for the changeability of the messages for the dispenser 12.

The dispenser 12 shown in FIGS. 1-4 includes an aperture through the first portionl 16 and a window 36 placed therein. Thus, the message identifier 24 is positioned adjacent the translucent to protect the message identifier from the elements of the environment to which the dispenser 12 is placed. The window 36 may include a clear cover, such as a clear polycarbonate cover for covering the viewing window and the message identifier 24. The cover is preferably a material having a high optical quality so as to provide aesthetic appeal to the message identifier 24 and readability of the message 26 thereon. In addition, the optical clarity of the cover may be varied to have the message 26 appear more glossy and professional without the addition printing expenses that would be required to make the message identifier appear glossy and professional when used without the cover or window 36. As mentioned, the window 36 also provides a barrier to protect the identifier 24 and thus the message 26 from being damaged or from fading over time. The barrier may protect the identifier from moisture for example.

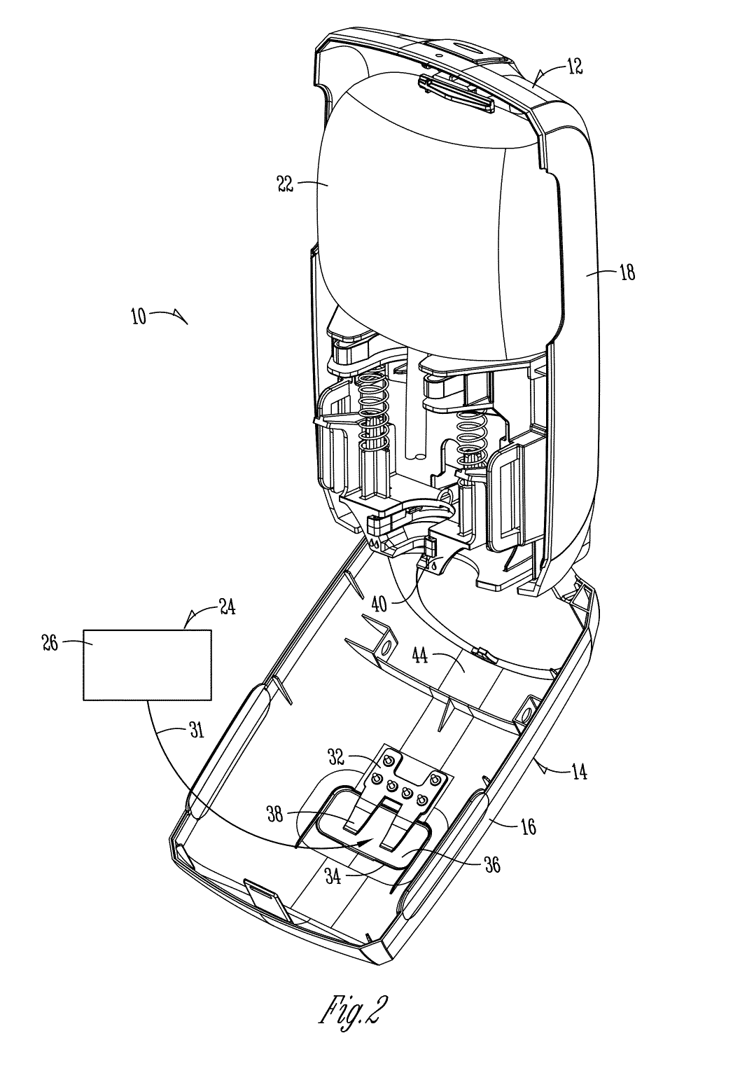

FIG. 2 is a perspective view of the dispensing system 10 of FIG. 1 in a generally open position. As discussed, the first portion 16 and second portion 18 of the body 14 are connected to another about a hinge 20. Therefore, the first portion 16 is able to move relative the second portion 18. The first portion 16 may be opened to replace the consumable product 22, or to provide access to the interior of the dispenser 12 to repair the dispenser. The dispenser can be closed by rotating the first portion 16 in a generally upward manner and snapping or otherwise locking the portions 16, 18 to one another. However, it should be appreciated that other means and mechanisms for providing access to the interior of the dispenser 12 are considered to be part of the present invention.

As shown in FIG. 2, a consumable product 22 can be housed between the first and second portions 16, 18 of the dispenser body 14. The consumable product 22 can be housed in a deformable bag or other container such that the contents of the bag may be removed or dispensed upon use of the dispenser 12. Once all the contents of the product 22 have been depleted, the dispenser can be opened and the consumable product 22, including its container, can be replaced such that additional product may be inserted and used with the dispenser 12.

Opening the dispenser body 14 also allows the message identifier 24 including the message 26 to be replaced and/or changed. For example, the message identifier 24 including the message 26 may be changed seasonally to account for different seasonal illnesses to remind the public of such illnesses in order to promote good handwashing practices and the promotion of good hygiene. Thus, the message identifier 24 can be a badge type device that can be made of thin plastic with a printed message 26 thereon. Making the identifier 24 out of plastic allows the identifier 24 to be water resistant and more resilient to ambient conditions. However, it should be appreciated that the identifier 24 may be made of other materials such as tag board, cardboard, or other types of paper, plastic, metal, or the like. Furthermore, the identifiers may also include additional members for aid in attaching the identifier 24 to the dispenser body 14. This allows a plurality of messages to be provided on a plurality of identifiers such that the identifiers can be easily replaced or changed to provide for a near infinite number of messages to be provided at the point of use of the dispenser 12. In the embodiment shown in FIGS. 1-4, the message identifier 24 can be positioned adjacent the window 36 on the interior 44 of the first portion 16 of the dispenser 12. This can be adjacent a recessed area 34 of the first portion 16 which may include the aperture through the first portion as mentioned above. The message identifier 24 is positioned such that the message 26 can be viewed through the window 36 such that a person can view the message through the window 36. To hold the identifier 24 in place, a holder 32 can be positioned on the interior or backside 44 of the first portion 16 and adjacent the window 36. The holder 32 comprises one or more retaining arms 38 extending from a base that is affixed to the first portion 16. The retaining arms 38 extend from the base of the holder 32 and provide a retention area between the arms 38 and the window 36. Thus, the identifier 24 can be slid between the retention arms 38 and the window to hold the identifier 24 in place and in position for viewing the message 26 through the window 36.

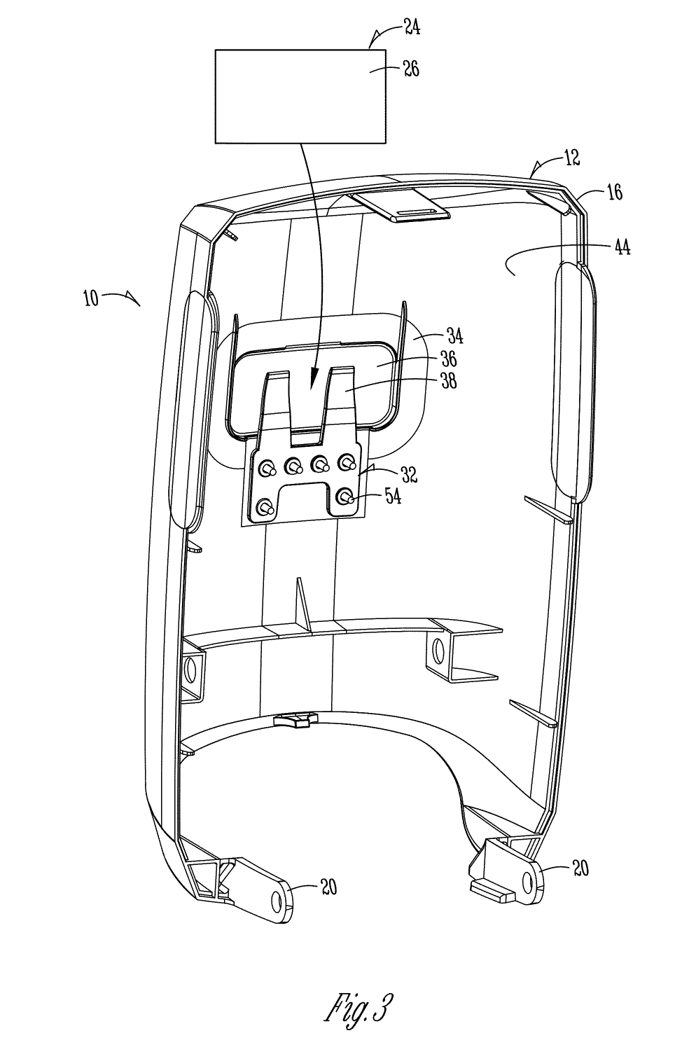

As shown by the arrows 31 in FIGS. 2 and 3, the identifier 24 can be slid over a top portion of the retention arms 38 and between the retention arms 38 and the window 36. The retention arms 38 exert a force generally towards the window 36, however, the force may be overcome to provide space to slide the identifier between the arms and the window. The retention arms 38 can also include some elasticity to re-exert tension to hold the identifier 24 in place adjacent the window 36. Furthermore, as shown in the figures, the holder 32 may be attached or otherwise affixed to the first portion 16 of the dispensing body 14 by screws 54. Other methods and means of attaching the holder 32 to the dispenser body 14 are contemplated to be part of the invention. For example, the holder 32 may be adhered to the dispenser body 14 via adhesive, screws, snaps, Velcro®, or the like. It is also contemplated that the holder be molded or otherwise formed as part of the dispenser body 14 such that it is integral one piece with the dispenser body 14.

Thus, the dispenser body 14 shown and described provides for a way to position a health related message on an identifier 24, while providing for the changeability of the identifier and/or message. For example, the dispenser can be opened and the message replaced or changed by removing the identifier from the holder and replacing the identifier with an identifier having a different message thereon. Thus, upon flu season, the message can be updated to remind the public of the flu season such that the public will be reminded to practice better handwashing techniques. In addition, upon the outbreak of an illness, such as avian flu, an identifier containing a badge alerting the public to the outbreak of the illness can be positioned in the dispenser to reduce the risk of transferring the illness by the promotion of good handwashing practices and overall good hygiene. Thus, the invention provides a method for promoting health and handwashing techniques by providing a plurality of health related messages directed to the promotion of health or directed to a health alert or instruction, and by allowing an operator to select a certain message to promote the hygiene and to communicate the hygiene tips and/or practices to reduce or mitigate the risk of transferring illnesses and/or diseases between people.

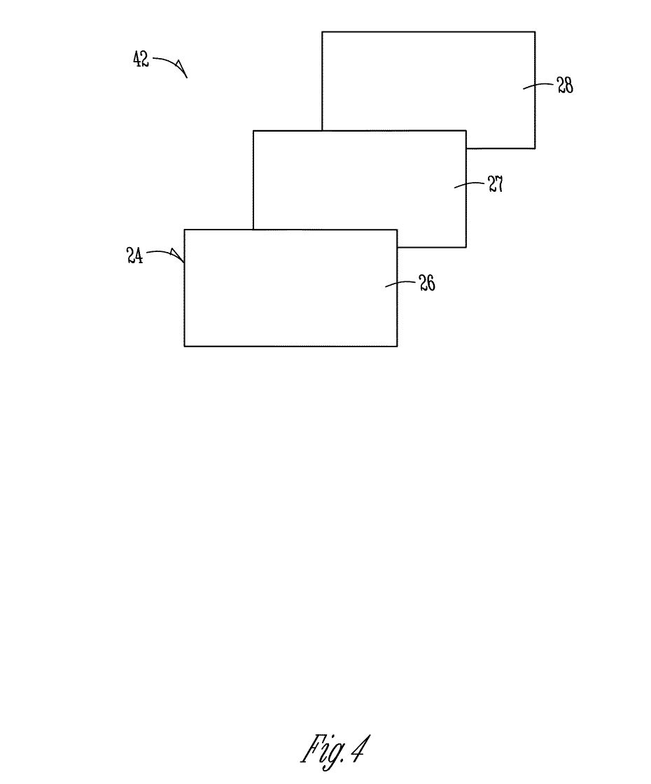

FIG. 4 is an illustrative view of a plurality of product identifiers 42 that can be used with the dispensing system 10 of the figures of the invention. As noted, the dispenser 12, as well as other dispensers contemplated for use with the present invention, can house and dispense a plurality of products. In addition, the dispensers 12 are contemplated for use over a long period of time. Thus, it should be appreciated that many different message may be included with the dispenser, or with an operator to allow for the interchangeability of the messages based upon a season, outbreak, pandemic, or change in recommended use or instructions for the product. Therefore, the present invention contemplates a dispenser housing a plurality of message identifiers 24, as shown in FIG. 4. The figure shows three message identifiers 26. The identifiers all include a different message thereon. For example, the front most identifier includes a first message 26, the middle identifier includes a different and second message 27, while the rear most identifier may include an nth message 28, where nth relates to any number of message which may be included with the dispenser. Thus, the operator may be able to interchangeably use and communicate the messages on the various identifiers at the dispenser to continuously update the public as to instructions, alerts, or general reminders regarding the use of the product to promote good handwashing and hygiene practices.

Therefore, an example of the use of the invention may be as follows. A product dispenser is, such as a soap dispenser may be provided for exemplary purposes. A message can be provided at the point of use of the soap dispenser. In addition, a plurality of additional messages may be provided for the dispenser. The messages comprise various reminders, instructions, alerts, facts, and other health or hygiene related messages. Thus, the messages relate generally to the promotion of good health and hygiene. The messages are provided at the dispenser to remind people of the benefits of good hygiene practice to reduce or mitigate the transfer of illnesses and/or diseases between people. In addition, the messages may provide instructions for the use of the product. When the product of the dispenser is a lotion, the message may include instructions as to the amount of lotion to use or to how often to use the lotion. When the product is soap, the instruction may relate to the amount of time of scrubbing of hands, rinsing of hands, or drying of hands. The message may include some combination of the above as well. The messages can be interchanged based upon season, illnesses, and conditions. For example, if an outbreak occurs, a message can be provided to alert the public of such an outbreak such that the public places a higher emphasis on their handwashing practices and overall hygiene to reduce the transfer of the illness. Furthermore, the message may include general foodborne disease facts such that food industry workers may remember to practice good health and hygiene in order to reduce the risk of transferring the diseases to their customers.

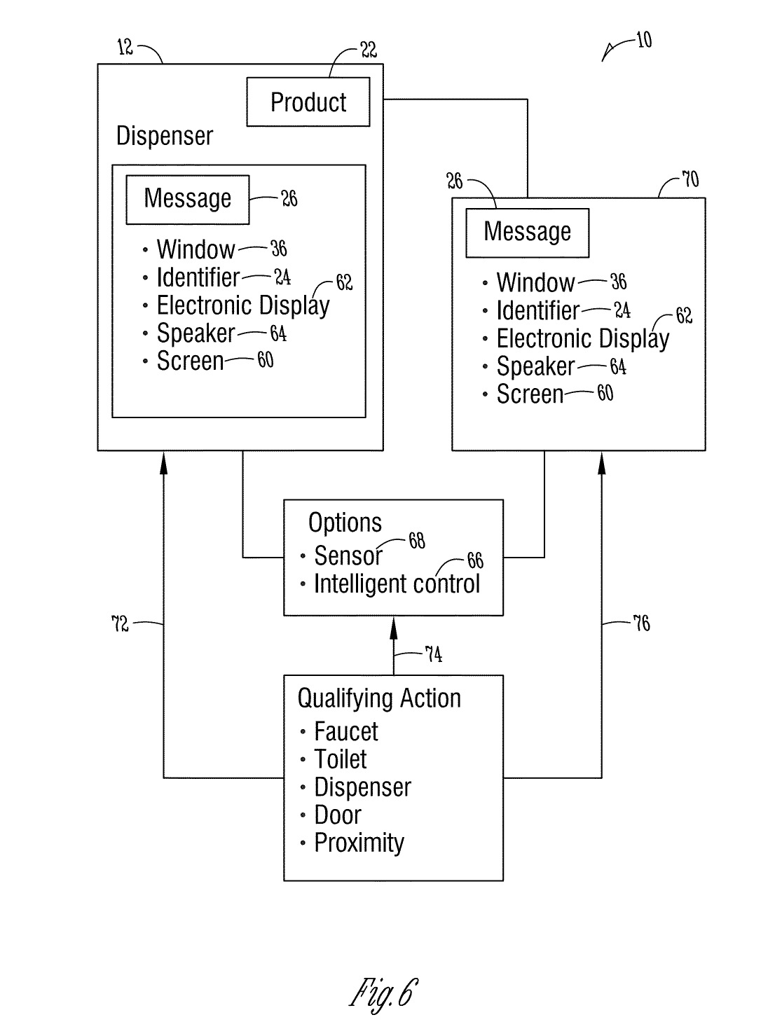

FIG. 6 is a schematic of a dispensing system 10 according to the present invention that includes various changes. The dispenser 12 shown in FIGS. 1-4 includes a plurality of messages for promoting good health and hygiene practices at the point of use of the dispenser 12. However, it should be appreciated that the messages may also be provided not at the point of use but near or in the vicinity of the dispenser, product, or other hygiene apparatuses. Such apparatuses may include dispensers, hand dryers, faucets, or the like.

FIG. 6 shows a dispenser 12 containing a consumable product 22 therein. As mentioned, a plurality of messages 26 related to the promotion of good health and hygiene practices may be associated with the product 22. FIG. 6 shows both the use of communicating the message 26 via a communication device 58 at the point of use of the dispenser 12, as well as a communication device 70 positioned near or in the vicinity of the dispenser 12. The communication device 58 at the point of use of the dispenser 12 may include a window and identifier combination 24, an electronic display 62, a screen 60, and/or a speaker 64 operatively or electronically connected to the dispenser 12. The window and identifier 24 situation was described above. A screen 60 may be included to provide a short video clip or a changing screen such that messages are continually changed on the screen to provide the plurality of messages 26 at the dispenser. An electronic display 62 may include a scrolling text including a scrolling set or plurality of messages at the dispenser 12 to provide for the plurality of messages at the dispenser. The speaker 64, which may be used alone or in combination with one of the other options of the communication device 58 may provide an audio clip containing instructions, alerts, reminders or general facts relating to good health and hygiene practices. The invention contemplates that only one of the options of the communication device may be provided at the point of use of the dispenser 12, or some combination of the options may be used as well to provide for one or more of the plurality of messages related to the promotion of health and hygiene.

In addition, a communication device 70 may be positioned near or within the vicinity of the dispenser 12, but not directly at the point of use of the dispenser 12. The communication device 70 may or may not be electronically connected to the dispenser such that it may operate on its own or may be synced with the dispenser 12. The secondary communication device 80 includes a plurality of messages 26 thereon which may be communicated via an identifier 24 and window 36, screen 60, electronic display 62, and/or speaker 64. As mentioned above, any of the options for the secondary communication device 79 may be used to provide for one or more of a plurality of health and hygiene related messages to promote good health and hygiene practices to reduce the transfer of illnesses and/or diseases.

As mentioned, the secondary communication device 70 may be electronically connected to the dispenser 12. Furthermore, an intelligent control 66 and sensor 68 may be electronically coupled to the dispenser and/or secondary communication device 70 to provide for one or more of a plurality of messages to be provided to a user based upon an action. For example, a sensor 68, such as a proximity sensor may be utilized with the system 10 to provide for a specified message to be displayed or communicated at one or both of the communication devices 58, 70 based upon an action of an individual. For example, upon flushing of a toilet, a sensor 68 may activate an intelligent control 66 to provide for an audio clip to remind the individual to use a product, such as soap, to promote good health and hygiene habits. Upon use of the soap and/or faucet, the sensor and/or intelligent control may activate one of the communication devices 58, 70 to provide for further instructions relating to the time for scrubbing of hands and/or hand drying techniques to further reduce the risk of transferring illnesses and/or diseases. The present invention contemplates other sensors may be utilized with items such as the door or dispenser. For example, upon entering a room through a door, a sensor may activate an intelligent control that activates one or both of the communication devices 58, 70 such that the communication devices may communicate a general health or hygiene fact or alert, to educate the individual prior to using any apparatus within the room of the benefits of good health and hygiene. Upon use of the facilities, a different message may be provided at one or both of the communication devices 58, 70 to provide for further instructions, tips, facts, or alerts to further drive home the importance of good health and hygiene practices to reduce or mitigate the transfer of illnesses and/or diseases.

Therefore, the present invention contemplates any number of communications devices in a room, such as a restroom to continually update an individual of instructions, alerts, risks, facts, of the like in order to promote good health and hygiene practices. Such practices may include handwashing by proper techniques of washing hand with soap for a recommended amount of time and drying in a recommended manner. Furthermore, other practices include the use of a lotion after washing the hands to reduce the risk of drying of the skin, which would cause open sores in the hands. Further recommendations, tips, and instructions may also be provided for additional types of products and overall health and hygiene practices. The present invention is not to be limited to the precise examples given.

The foregoing description has been presented for purposes of illustration and description, and is not intended to be an exhaustive list or to limit the invention to precise forms disclosed. It is contemplated that other alternative processes obvious to those skilled in the art are considered to be included in the invention. From the foregoing, it can be seen that the present invention accomplishes at least all the stated objectives. Thus, a method and means for promoting good health and hygiene have been provided. It is to be appreciated that the method of promoting the good health and hygiene practices by use of providing a plurality of interchangeable messages at or near a point of use of a dispenser related to health and hygiene of an individual may reduce the risk of transferring illnesses and/or diseases, such as foodborne diseases between individuals.

What is claimed is:

1. A method of promoting health and hygiene, comprising:
providing a plurality of health-related messages directed to the promotion of health;
selecting a health-related message based upon a suggested behavior or an alert; and
communicating the health-related message at or near a product dispenser related to the selected message to promote the use of the product.

2. The method of claim 1 wherein the step of communicating comprises displaying the health-related message on an identifier at or near the product dispenser.

3. The method of claim 2 further comprising changing the identifier to provide a new health-related message based upon a change in product, season, alert, or location.

4. The method of claim 1 wherein the step of communicating comprises displaying the health-related message on an electronic display at or near the product dispenser.

5. The method of claim 4 further comprising remotely changing the electronically displayed health related message to a new message.

6. The method of claim 1 wherein the step of communicating comprises an audio clip played at or near the product.

7. The method of claim 1 further comprising providing a sensor to automatically communicate the health-related message upon an action.

8. The method of claim 7 wherein the action comprises:
a. entering a room;
b. flushing a toilet;
c. turning on a faucet; or
d. passing adjacent the product.

9. The method of claim 1 wherein the health-related messages comprise:
a. one or more messages related to food safety;
b. one or more messages related to a hygiene reminder;
c. one or more messages related to a health alert;
d. one or more messages related to a seasonal health condition; or
e. one or more messages related to an instruction for the product.

10. The method of claim 9 wherein the health-related messages comprise a plurality of languages.

11. A system for promoting health and hygiene, comprising:
a plurality of health-related messages directed to the promotion of health; and
a communication device for communicating a selected health-related message at or near a product dispenser related to the selected message;
wherein the communication device includes means for changing the communicated health-related message.

12. The system of claim 11 wherein the communication device comprises a message identifier attached at or near the product dispenser.

13. The system of claim 11 wherein the communication device comprises an electronic screen.

14. The system of claim 11 wherein the communication device comprises a loudspeaker.

15. The system of claim 11 further comprising a sensor electrically connected to the communication device such that the sensor activates the communication device based upon an action.

16. The system of claim 11 wherein the health-related messages comprise:
a. one or more messages related to food safety;
b. one or more messages related to a hygiene reminder;
c. one or more messages related to a health alert;
d. one or more messages related to a seasonal health condition; or
e. one or more messages related to an instruction for the product.

17. A method of promoting health and hygiene, comprising:
providing a plurality of health-related messages directed to the promotion of health;
selecting a health-related message based upon a suggested behavior for a product related to health; and
displaying the health-related message at a product dispenser to promote the use of the product.

18. The method of claim 17 further comprising providing instructions related to the use of the product.

19. The method of claim 17 wherein the step of displaying the health-related message at the product comprises providing a message identifier at the product that displays a health-related message comprising at least one of:
a. a message related to food safety;
b. a message related to a hygiene reminder;
c. a message related to a health alert;
d. a message related to a seasonal health condition; or
e. a message related to an instruction for the product.

20. The method of claim 17 wherein the product comprises a soap, detergent, disinfectant, lotion, or food safety product.
